(19) United States
(12) Patent Application Publication
(10) Pub. No.: US 2006/0294387 A1
(43) Pub. Date: Dec. 28, 2006

(54) Method of controlling access

(76) Inventors: Douglas William McCracken, Olney (GB); John McHardy Brand, Edinburgh (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/556,694

(22) PCT Filed: May 13, 2004
(86) PCT No.: PCT/GB04/02068

§ 371 Date: Nov. 15, 2005

(30) Foreign Application Priority Data
May 15, 2003 (GB) 0311178.8

(51) Int. Cl. H04L 9/00

(52) U.S. Cl. 713/182

(57) ABSTRACT

A method of controlling access comprises detecting at least one access request containing a specified caller number and storing the specified caller number and the time of the request, detecting at least one call, identifying the caller number and storing the identified caller number and time of the call. The access request is denied unless the specified caller number of the access request matches an identified caller number, and the time between that access request and the call is less than a predetermined period.

The invention relates to a method and a system for controlling access to a secure computer system or, via a computer system, to a resource, location or event.

In particular, but not exclusively, the invention relates to a method for authenticating a user's right to access a secure computer system, and for identifying the user in order to control the user's access to restricted parts of the computer system, which are restricted according to the identity of the user. It also relates to a method and system that allows a user of the Internet to authenticate his right to access material provided by an Internet server. According to a further aspect, the invention relates to a method and system for controlling access to a resource, location or event, via a computer system. This last aspect includes, for example, controlling access to physical objects, to buildings and vehicles and to cultural, sporting or other events.

The burgeoning use of the Internet as a medium both for distributing information and for providing access to products and services has been a major driver for increased security; and conversely, the perceived lack of security available to protect Internet-based information exchange continues to be a major disincentive to companies' use of the medium. The Internet is dramatically changing the way both business and public organisations operate, by breaking down geographical limitations and producing cost savings. There is great pressure to resolve the security issues, and in particular to ensure that only authorised users can access information and services: transactions require trust, and those companies that can offer this online gain significant competitive advantage.

The ability to control access is also very important in relation to other secure computer systems, such as computer networks and operating systems. There is also a need to control access to various resources, locations and events, and in certain circumstances this can be implemented with greater efficiency via a computer system.

Most existing authentication methods used in relation to secure computer systems rely on the use of a User Identification (User ID) and a secret passcode, in the form of a password, pass phrase or personal identification number (PIN). Each user has a unique User ID and a secret passcode known only to the user. The User ID and passcode are stored in a database by an authentication server, which controls access to the secure computer system. To authenticate himself to a secure computer system, the user claims to be the “owner” of a specific User ID, and substantiates that claim by providing a passcode associated with that User ID and known only to him.

For example, in order to access a restricted website the user sends a message via a browser to the web server, containing the claimed User ID, and the associated passcode to substantiate this claim. The server then compares the message with the recorded details and accepts the claimed User ID only if these details are consistent.

The authentication method described above provides only a limited degree of security, since it is possible the user's User ID and passcode may be discovered, stolen or guessed by an unauthorised person.

A higher degree of security may be provided by using a “two-factor” authentication process, which relies on both knowledge of a secret passcode and possession of a unique object or device known as a token. The proof that the user possesses the token further substantiates the claimed User ID, over and above the proof offered by the knowledge of the passcode. Tokens used in existing authentication methods include smartcards and USB tokens that connect directly to a computing device such as a PC, and small tokens with a display providing a time-based code synchronised with the authenticating website so that if the code submitted by the user matches that produced by the website, possession of the token may be assumed.

Telephone devices, for example mobile phones, may be used as tokens to provide the second authentication factor. After the user has identified himself by entering his User ID and postcode, proof of the possession of the registered telephone by the user is provided by requesting the user (identified by his User ID) to make a telephone call to the number of the authentication server, which identifies the telephone number of the caller using calling line identification (CLI). The authentication server, which includes a database containing the User IDs and telephone numbers of all authorised users, attempts to match the number of any received call to the telephone number associated with the claimed User ID. If a call from the matching number is received within a given time, the authentication server grants the authentication request. A system of this general kind is described for example in WO 01/99378 (ICL Invia Oyj).

Telephone devices, for example mobile phones, may also be used to deliver an alternative type of second authentication factor. A token need not be a physical device, but may take the form of a unique secret access code to be used once only, produced by the authentication server when an authentication request has been received. This one-time secret may be provided to the user by transmission via SMS text messaging to the mobile telephone associated with the user's User ID: the user then proves that he has received it by returning the one-time secret via the browser. Thus, the telephone is used as a medium for transmission of this unique secret access code. This method has the advantage that the secret access code is used only once, and cannot be used again if discovered or disclosed. The main disadvantage of this method is that SMS text messages may be delayed or intercepted. Such a system is described for example in WO 02/37240 (British Telecommunications pic).

According to other systems, either the passcode or the token may be replaced in two-factor authentication methods by the use of biometric data (for example, a finger print or iris pattern).

All the above methods have the disadvantage that the user must begin by providing his unique User ID, and then substantiate his claim to own that ID by producing first a passcode to substantiate that claim, and then a second authentication factor, for example the possession of a token, to further substantiate the claim. Variations that substantiate the claimed User ID in a different order provide no security advantages.

User IDs are not normally considered as secret and do not themselves contribute to the security of the logon process: indeed, in most applications they are easily guessable, frequently consisting of some combination of the user's names and initials. Conversely, because by definition they need to be unique, they may be difficult to remember—a user with a common name and needing to access several different websites will probably have to deal with numerous different User IDs.

It is an object of the present invention to provide a highly secure authentication method which does not require the user to provide a User ID or to possess any additional devices beyond those he would normally carry.

According to the present invention there is provided a method of controlling access, comprising detecting at least one access request containing a specified caller number and storing the specified caller number and the time of the request, detecting at least one call, identifying the caller number and storing the identified caller number and time of the call, and denying the access request unless the specified caller number of the access request matches an identified caller number, and the time between that access request and the call is less than a predetermined period.

The method does not rely on the use of User IDs or passwords. Instead, the user's caller number is used as the primary means of identification, and to authenticate his identity the user must have knowledge of his caller number and possession of the telecommunications device having that number. The need for User IDs and passwords is thus avoided and the inconvenience and risks associated with systems that rely on those identifiers are therefore mitigated. Using the invention, it is also possible to avoid the need to complete a registration process prior to using the access control system.

Advantageously, the method includes storing a set of caller numbers, comparing the specified caller number contained in the access request with the stored set of caller numbers, and denying the access request unless the specified caller number matches one of the stored set of caller numbers.

Advantageously, the method includes storing a set of passcodes, each passcode being associated with a stored caller number, detecting a passcode, and denying the access request unless the detected passcode matches the stored passcode associated with the specified caller number.

Advantageously, the method includes storing a set of identity codes, each identity code being associated with a stored caller number, in the case of a successful access request, providing the identity code associated with the specified caller number to a third party. The third party may, for example, be a secure computer system or associated software as required.

Advantageously, the access request and the call are received via different channels of communication.

The method may be for controlling access to a secure computer system, or for controlling access via a computer system to a resource, location or event.

According to a further aspect of the invention there is provided a system for controlling access, comprising first detecting means for detecting at least one access request containing a specified caller number, and storing means for storing the specified caller number and the time of the request, second detecting means for detecting at least one call, identifying means for identifying the caller number and second storing means for storing the identified caller number and time of the call, and access control means for denying the access request unless the specified caller number of the access request matches an identified caller number, and the time between that access request and the call is less than a predetermined period.

Advantageously, the system includes store means for storing a set of caller numbers, and comparison means for comparing the specified caller number contained in the access request with the stored set of caller numbers, wherein the access control means denies the access request unless the specified caller number matches one of the stored set of caller numbers.

Advantageously, the system includes store means for storing a set of passcodes, each passcode being associated with a stored caller number, and detection means for detecting a passcode, wherein the access control means denies the access request unless the detected passcode matches the stored passcode associated with the specified caller number.

Advantageously, the system includes store means for storing a set of identity codes, each identity code being associated with a stored caller number, the system being configured such that in the case of a successful access request, the identity code associated with the specified caller number is provided to a third party.

Advantageously, the access request and the call are received via different channels of communication.

The system may be for controlling access to a secure computer system, or for controlling access via a computer system to a resource, location or event.

According to an embodiment of the present invention there is provided an authentication method for allowing or denying access to a restricted computer application, in which an authentication server receives an access request and a call from a telecommunications device, for example a mobile phone, said access request specifying a telephone number. The server notes the time of the access request, for a predetermined time checks incoming calls received on a telecommunications device, compares the numbers of incoming calls, derived from call signalling for example calling line identification, with the telephone number specified in the access request, and permits access if the number specified in the access request matches the telephone number of an incoming call, identified by calling line identification.

This method is a simple single-factor authentication method, which has the advantage that no form of User ID or passcode needs to be provided, remembered or protected. It provides a degree of security because the user will not be allowed access unless he possesses the mobile phone whose number is specified in the access request made via the browser. The method requires a minimal level of administration and management, as there is no need to create, allocate, deliver and protect User IDs and passwords.

Additional security may be provided by the telephone user to prevent use of the telephone by unauthorised persons. This additional security may be provided by using security features provided with the telephone handset itself, for example, a user-defined PIN which must be entered before a call is made.

Further, the system may be configured such that the access request is granted only if the calling phone number has been pre-registered with the authentication server. In this case, when a matched call has been received, the server checks that the number is listed in an associated database, and access is only permitted if this is the case.

In contrast to the first method, in which any user possessing a mobile telephone will be granted access, this method ensures that access will be permitted only to users whose mobile phone numbers have been accepted for registration. This has the further advantage that mobile phones may be simply de-registered, thus revoking the user's access.

Further, once a matched call has been received the authentication server may request a passcode to be checked against a pre-registered passcode associated with the telephone number specified in the access request. Only if these are found to match will access be granted.

This method provides a simple and highly secure form of two-factor authentication. It has the advantages over other two-factor schemes described above that the user is not required to remember a User ID, carry any form of physical token other than his standard mobile phone, or wait for the arrival of an SMS message or e-mail.

Further, if access is granted, the identity of the user may be derived from information provided during the authentication process and provided to other third party software, for example to control his degree of access, the level of service provision he receives or billing for information and services provided.

This method has the advantage over other two-factor authentication methods described that the identity of the user, if required, is established and provided without the need for the user to remember a User ID.

In the present invention, authentication depends primarily on possession of a telephone device with a unique specified number, and is optionally corroborated by a passcode associated with the unique number of the telephone device. The user's identity is not a prerequisite for authentication.

In the present invention, there is no requirement for a person requesting access to a restricted computer system to provide an identity code, a name, a user name, a ‘User ID’ or any similar code. The user does not need to identify himself for authentication. The user's identity may optionally be determined from the mobile phone number, if this has been pre-registered and is required by the restricted computer system—for example for billing, audit or further access control purposes.

The mobile phone may be used to provide access to a secure system where the identity of the person accessing the system is not required for the provision of goods and services, in that there is no requirement to relate individual information, facilities or services to the person accessing the system, but where these cannot be supplied or billed for unless the telephone number is known to the supplier. An example of this is electronic voting by voters who are entitled to vote, where a voter must be pre-registered to vote, but advantageously there is a need to disassociate the vote cast online by the voter with the identity of the voter. It is sufficient that the telephone be pre-registered, and it is desirable that there be no association of the act of voting with the vote itself. It is sufficient to know that the person in possession of the mobile telephone has voted, in order to ensure that further votes are not received from that person. The person possessing the mobile telephone requests access to the secure system and quotes the number of the mobile telephone. The person then makes a short unanswered call to the number of the service provider, which recognizes the number of the call and matches it with the quoted number, and if pre-registered grants the access request and accepts the vote. The vote is recorded separately from the request to vote, which is associated with the mobile phone number. Any subsequent attempts to vote within a given time period using the same mobile phone number will be refused.

In a variation of the above voting example, it may not be necessary to pre-register in order to vote. Votes may be accepted from any user who has a mobile phone.

In another example, the mobile phone may be used to provide access to a secure system where the identity of the person accessing the system is not required but where, in order to provide the goods or services, it is necessary that the user be able to pay or be billed for the goods or services. This may be used in provision of goods and services which are billed to the phone owner's account with the phone service provider's billing systems. The identity of the phone user is not needed at the time the service or product is provided, it is however necessary that the phone number be pre-registered. An example of this is in provision of low-value goods and services from an Internet website or from a vending machine. In order to use the method, the user must request pre-registration before use. To use the method, the person possessing the mobile telephone requests access to the secure system and quotes the number of the mobile telephone. The person then makes a short unanswered call to the number of the service provider, which recognizes the number of the call, and matches it with the quoted number, and if the user has pre-registered the phone number, grants the access request and bills the goods or services provided to the account of the phone owner, providing that the phone service provider's billing system does not reject the billing transaction.

In a variation of the above example, it may not be necessary to pre-register in order to obtain goods and services, which may be provided to any user who has a mobile phone, and where the phone service provider will accept a billing request.

In any application of the method which requires a user to pre-register the mobile phone number, a further level of confidence and security can be provided by the use of a secret passcode associated with the mobile telephone, which is created at the time of registration of the mobile telephone, and is maintained separately. Systems can recognize the mobile phone number as in previous examples, and request the secret passcode to be input via a browser if a web application, or via a keypad attached to a vending machine.

Where access to secure systems is controlled so as to allow access only to authorised individuals, and resources are provided according to the identity of the individual by an authorisation system, it is important that the authentication process can provide the identity of the person. In the present invention the user possessing the mobile telephone requests access to the secure system and specifies the number of the mobile telephone. The person then makes a short unanswered call to the authentication server, which recognises the number of the call and matches the call with the specified number. If that number has been pre-registered with the secure system, and an identity code for the person holding the mobile phone has also been pre-registered, the secure system can provide that identity to allow authorisation. Optionally, a passcode may be requested, as in previous examples.

The above examples refer to circumstances where a person in possession of a mobile phone requires access to a secure system. It is a preferred object of the present invention that a mobile phone and a telephone call from that mobile phone can be used in conjunction with a separate communications channel (such as the internet) to provide authentication of both persons and computer systems to secure systems. An example of this is the use of a GPRS or 3G mobile phone or enhanced Personal Digital Assistant (PDA) device to access a secure system, according to any of the examples above where access to a secure web service is required. Rather than the person holding the mobile phone directly initiating the unanswered call to the authentication server, the phone itself may be programmed to call automatically, in parallel, either before or after the device is connected to the secure web service. The mobile phone or PDA will automatically provide the number of the mobile phone or PDA to the secure web service via the web connection. The authentication server may recognize the incoming call, and associate it with the number provided. The identity of the device has thus been provided via two separate channels (the standard telephone voice network and the mobile Internet Protocol web network) for authentication. Optionally, a passcode may be requested, as in previous examples. This automated method provides secure two-factor authentication using two channels, which may be used for machine-to-machine communication, where devices are provided with both a standard telephone connection (for voice communications) and an Internet Protocol web connection (for data communications).

Various embodiments of the invention will now be described, by way of example, with reference to the following drawings, in which:

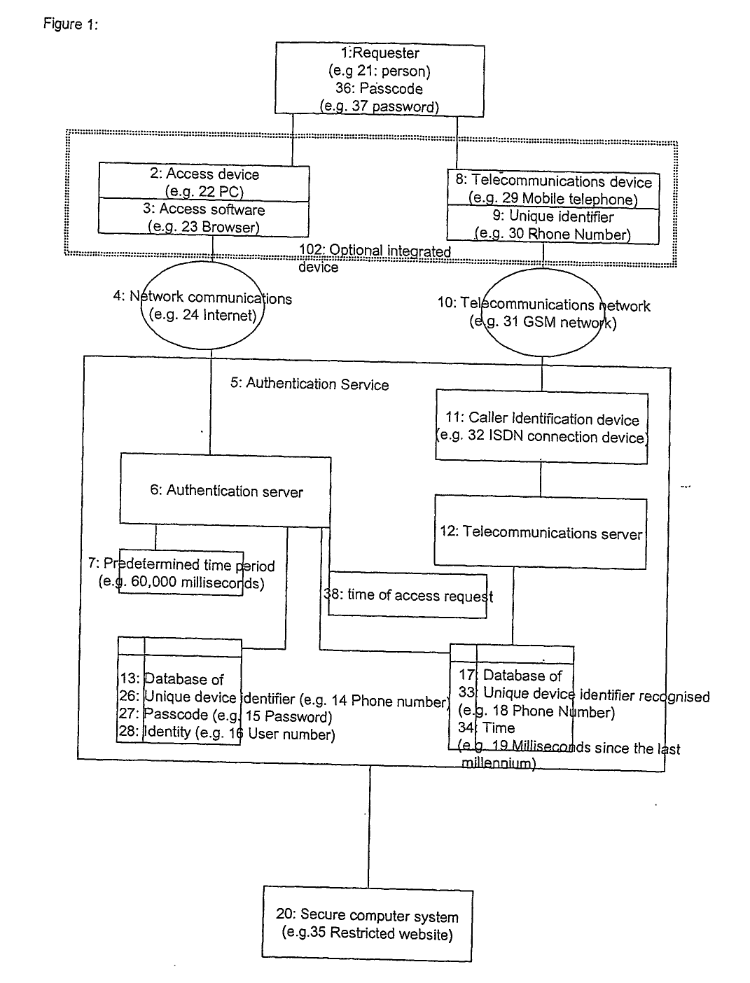

FIG. 1 is a system diagram illustrating schematically the main components of an authentication system;

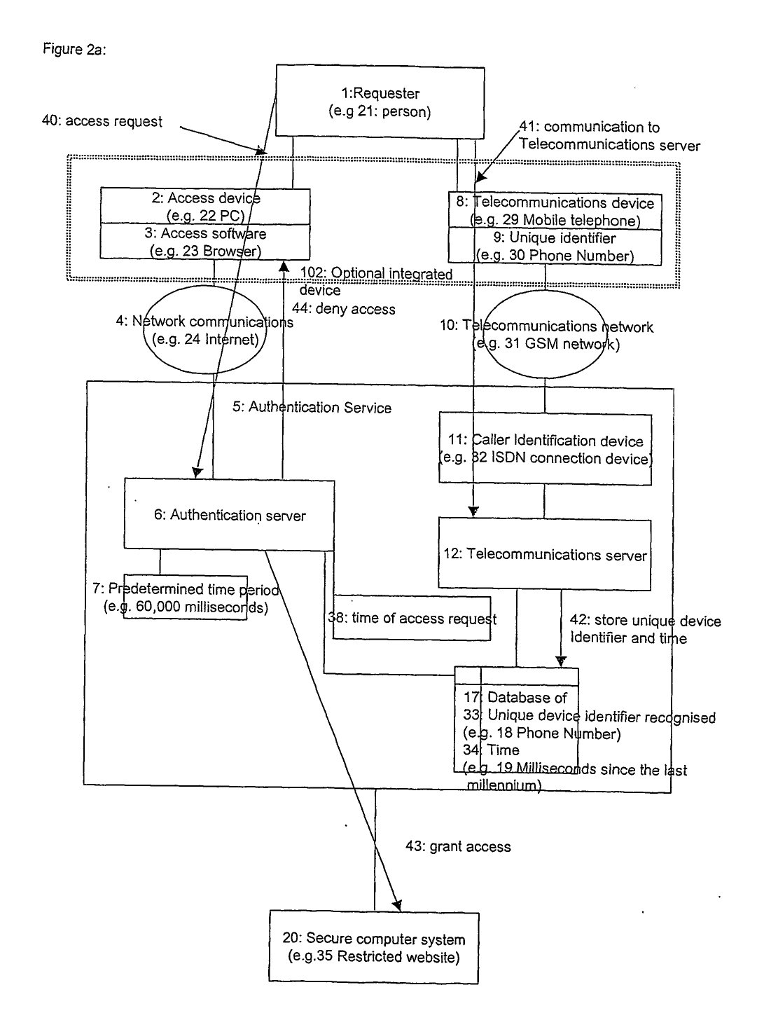

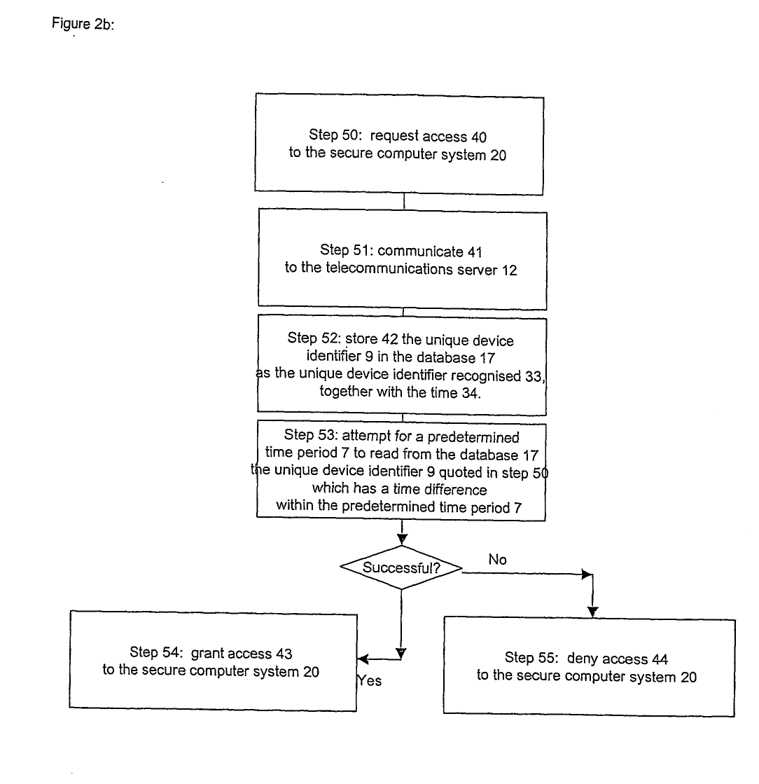

FIG. 2a is a system diagram illustrating schematically the main components of a first authentication method, together with authentication events;

FIG. 2b comprises a flow diagram illustrating the steps of a first web authentication method;

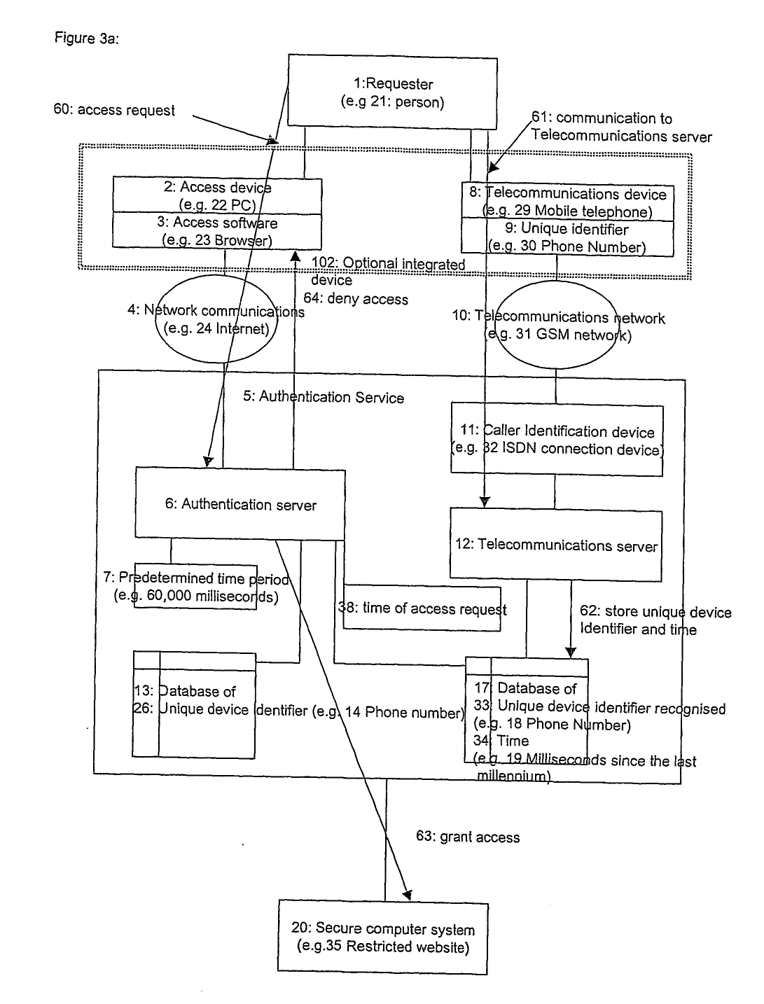

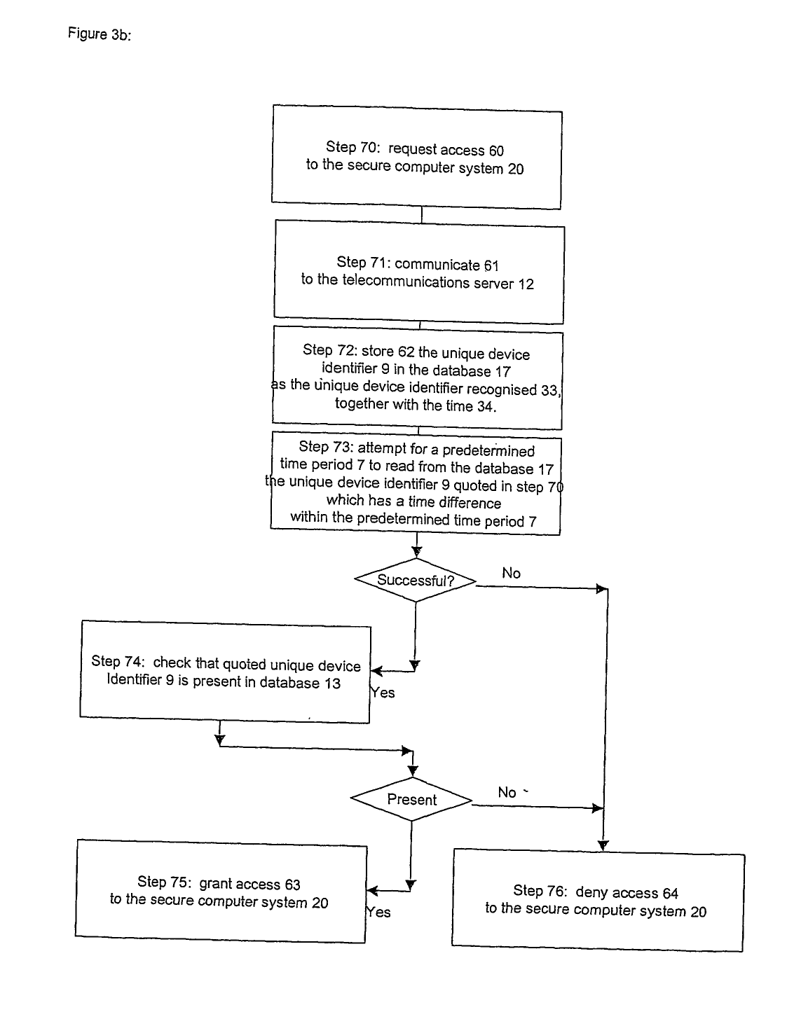

FIG. 3a is a system diagram illustrating schematically the main components of a second authentication method, together with authentication events;

FIG. 3b comprises a flow diagram illustrating the steps of a second web authentication method;

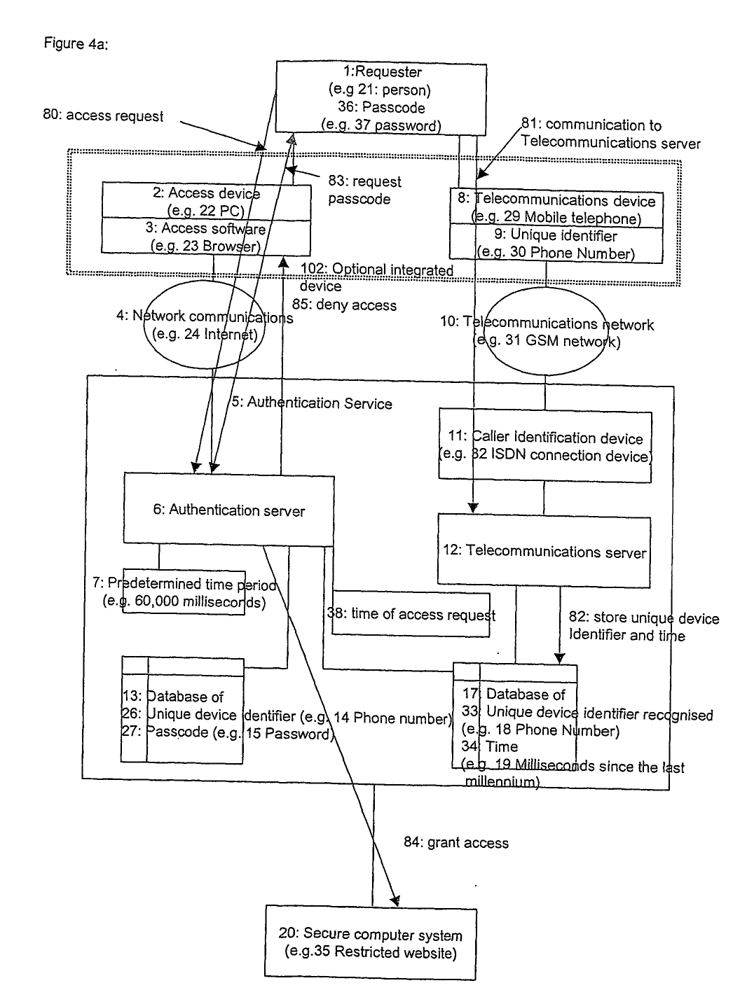

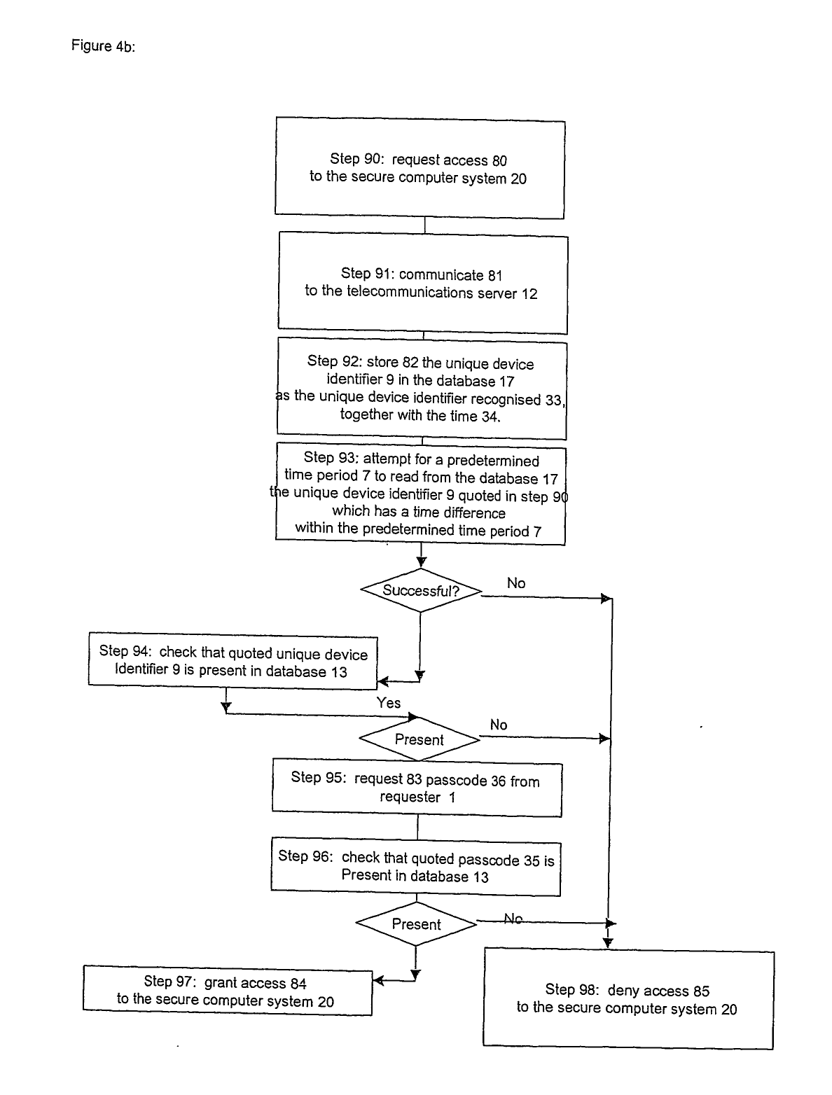

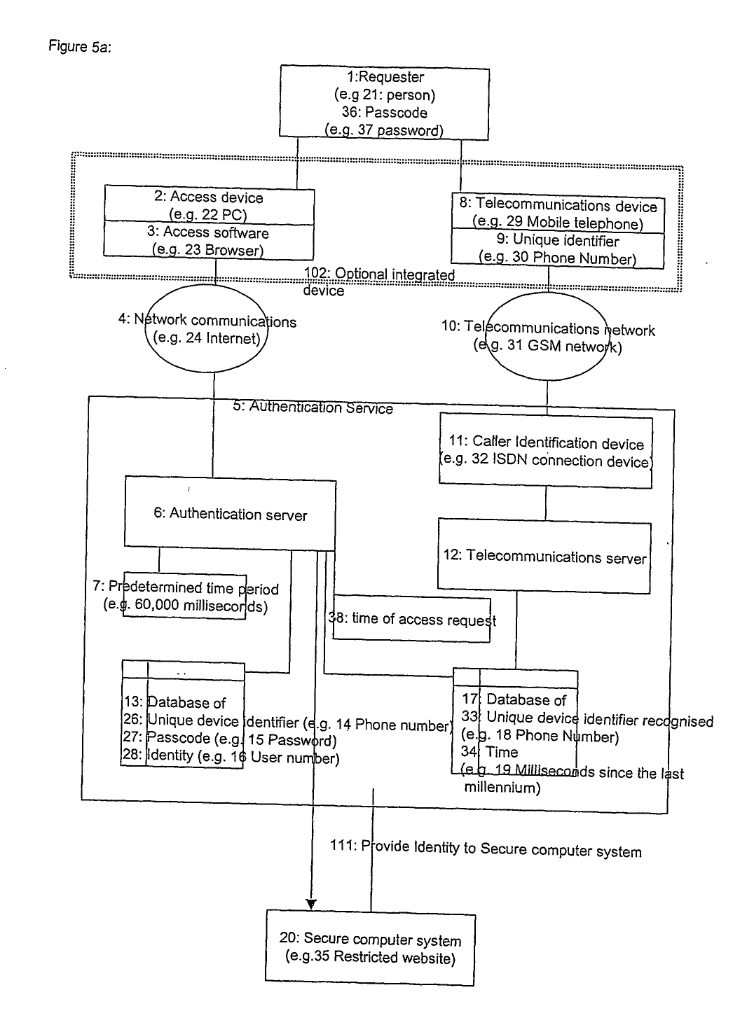

FIG. 4a is a system diagram illustrating schematically the main components of a third authentication method, together with authentication events;

FIG. 4b comprises a flow diagram illustrating the steps of a third web authentication method;

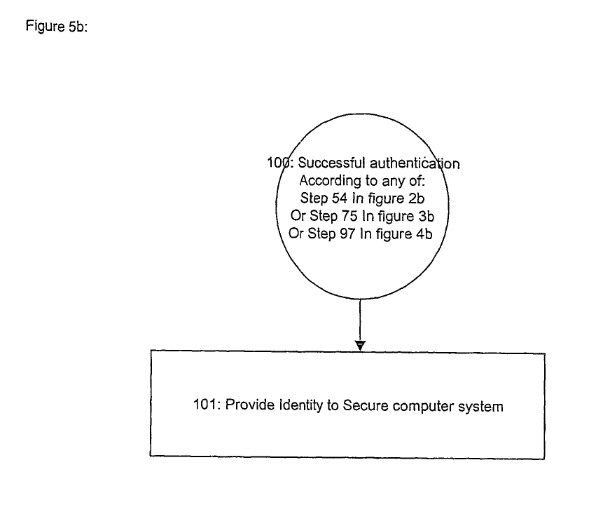

FIG. 5a is a system diagram illustrating schematically the main components of a fourth authentication method, together with authentication events; and

FIG. 5b comprises a flow diagram illustrating the steps of a fourth web authentication method.

An example of a web authentication scheme and a subsequent identification scheme according to the present invention is shown in FIG. 1 of the drawings. In this case, the invention will be described with reference to a system for controlling access to a secure computer system, being a restricted website accessed via the internet. It should be understood, however, that the system is also applicable to other restricted computer systems and to controlling access to other systems and devices, including for example, for controlling access to computer networks and to vending machines.

The system includes an access device 2, which may for example be a personal computer (PC) 22 or a personal digital assistant (PDA) that is used by a requester 1, for example a person 21, to access the World Wide Web.

The person 1 may possess a passcode 36, for example a password 37. The access device 2 with access implemented by access software 3, for example a browser 23, is linked via the network communications 4, for example the Internet 24, to an authentication service 5.

The authentication service 5 includes an authentication server 6, a stored predetermined time period 7, for example sixty seconds 25, a stored time of an access request 38, a database 13 that contains for each authorized user a unique device identifier 26, for example phone number 14, a passcode 27, for example password 15, and an identity 28, for example User Number 16; a database 17 of recognised unique device identifiers 33, for example phone number 18, and time 34, for example milliseconds since the last millennium 19, a caller identification device 11, for example an ISDN connection device 32, and a telecommunication server 12. Alternatively, the caller identification device may use standard and well-known methods and protocols such as SS7 or SIP.

The authentication service 5 is also linked to a secure computer system 20, for example a restricted website 35.

The requester 1 also possesses a telecommunications device 8, for example a mobile phone 29, which has a unique identifier 9, for example a phone number 30. It can be used to make a call to the telecommunications server 12 via a telecommunications network 10, for example a GSM network 31, and a caller identification device 11.

Optionally, the access device 2 having access software 3 and the telecommunications device 8 with the unique identifier 9 may be combined in a single integrated device 102, as will be described in more detail below,

There is a secure computer system 20 for example a restricted website 35 which may be accessed on successful authentication.

The telephone 29, the ISDN connection device 32, the internet 24, the GSM network 31, the PC 22 and browser 23 are conventional and will not be described in detail.

The steps of an authentication process according to a first embodiment of the invention will now be described with reference to the flow diagram shown in FIG. 2a.

In order to use the secure computer system 20, the requester 1 need not first be registered with the authentication service 5.

In the first step 50 of the authentication process, a requester 1 who wishes access to the secure computer system 20 makes an access request 40 to the authentication server 6, via the network communications 4 and when prompted to do so quotes the unique identifier 9 of his telecommunications device 8. The access software 3 submits the access request 40 to the authentication server 6.

In the second step 51 of the authentication process, the requester 1 communicates 41 to the telecommunications server 12 via the telecommunications network 10. The unique identifier 9 of the telecommunications device 8 is detected by the caller identification device 11. The communication 41 is not answered.

In the third step 52 of the authentication process, the telecommunications server 12 stores 42 the unique device identifier 9 in the database 17 as the recognised unique device identifier 33, together with the time 34.

In the fourth step 53 in the authentication process, the authentication server 6 will note the time 36 of the access request 40 and attempt for a predetermined time period 7 to read from the database 17 the unique device identifier 9 quoted in step 50 which has a time difference between the time of the access request 38 and time 34 within the predetermined time period 7.

In the fifth step 54 of the authentication process, the authentication server 6 will grant access 43 to the secure system 20 if the attempt in step 53 to read the unique device identifier 9 within the predetermined time period 7 is successful.

In the sixth step 55 of the authentication process, the authentication server 6 will deny access 44 to the secure system 20 if the attempt in step 53 to read the unique device identifier 9 is unsuccessful.

The steps of an authentication process according to a second embodiment of the invention will now be described with reference to the flow diagram shown in FIG. 3a.

In order to use the secure computer system 20, the unique device identifier 9 associated with the requester 1 must first be registered with the authentication service 5 and stored in database 13.

In the first step 70 of the authentication process, a requester 1 who wishes access to the secure computer system 20 makes an access request 60 to the authentication server 6, via the network communications 4 and when prompted to do so quotes the unique identifier 9 of his telecommunications device 8. The access software 3 submits the access request 60 to the authentication server 6.

In the second step 71 of the authentication process, the requester 1 communicates 61 to the telecommunications server 12 via the telecommunications network 10. The unique identifier 9 of the telecommunications device 8 is detected by the caller identification device 11. The communication 61 is not answered.

In the third step 72 of the authentication process, the telecommunications server 12 stores 62 the unique device identifier 9 in the database 17 as the recognised unique device identifier 33, together with the time 34.

In the fourth step 73 in the authentication process, the authentication server 6 will note the time 36 of the access request 60 and attempt for a predetermined time period 7 to read from the database 17 the unique device identifier 9 quoted in step 70 which has a time difference between the time of the access request 38 and time 34 within the predetermined time period 7.

In the fifth step 74 of the authentication process, which is reached only if step 73 is successful, the authentication server 6 interrogates the database 13 for the quoted unique device identifier 9.

In the sixth step 75 of the authentication service, which is reached only if step 74 is successful, it grants access 63 to the secure system 20.

In the seventh step 76 of the authentication process, the authentication server 6 will deny access 64 to the secure system 20 if the attempt to read the unique device identifier 9 in step 73 is unsuccessful, or the interrogation of database 13 In step 74 is unsuccessful.

The steps of an authentication process according to a third embodiment of the invention will now be described with reference to the flow diagram shown in FIG. 4a:

In order to use the secure computer system 20, the unique device identifier 9 associated with the requester 1 must first be registered with the authentication service 5 and stored in database 13 as unique device identifier 26, together with a passcode 27.

In the first step 90 of the authentication process, a requester 1 who wishes access to the secure computer system 20 makes an access request 80 to the authentication server 6, via the network communications 4 and when prompted to do so quotes the unique identifier 9 of his telecommunications device 8. The access software 3 submits the access request 60 to the authentication server 6.

In the second step 91 of the authentication process, the requester 1 communicates 81 to the telecommunications server 12 via the telecommunications network 10. The unique identifier 9 of the telecommunications device 8 is detected by the caller identification device 11. The communication 81 is not answered.

In the third step 92 of the authentication process, the telecommunications server 12 stores 82 the unique device identifier 9 in the database 17 as the recognised unique device identifier 33, together with the time 34.

In the fourth step 93 of the authentication process, the authentication server 6 will note the time 36 of the access request 80 and attempt for a predetermined time period 7 to read from the database 17 the unique device identifier 9 quoted in step 90 which has a time difference between the time of the access request 38 and time 34 within the predetermined time period 7.

In the fifth step 94 of the authentication process which is reached only if step 93 is successful, the authentication server 6 will interrogate the database 13 for the quoted unique device identifier 9.

In the sixth step 95 of the authentication service which is reached only if step 94 is successful, the authentication server 6 will request 83 the requester 1 to provide a passcode 36 via the access device 2 and the access software 3.

In the seventh step 96 of the authentication service, the authentication server 6 will interrogate the database 13 entry for the quoted unique device identifier 9, and compare the passcode 35 with the stored passcode 27.

In the eighth step 97 of the authentication service which is reached only if step 96 is successful, it will grant access 84 to the secure system 20.

In the ninth step 98 of the authentication process, the authentication server 6 will deny access 85 to the secure system 20 if the attempt to read the unique device identifier 9 in step 93 is unsuccessful, or the interrogation of database 13 in step 74 is unsuccessful, or the passcode 36, 27 match in step 96 is unsuccessful.

The steps of an authentication process according to a fourth embodiment of the invention will now be described with reference to the flow diagram shown in FIG. 5a:

In order to use the secure computer system 20, the unique device identifier 9 associated with the requester 1 must first be registered with the authentication service 5 and stored in database 13 as unique device identifier 26, together with an identity 28.

In step 100 of the authentication process, which is reached only if an authentication is successful according to the steps described in the second or third embodiments of the invention shown in FIGS. 3b and 4b respectively, the authentication server 6 will interrogate the database 13 using the quoted telecommunications device identifier 9 to obtain the identity 28.

In the final step 101 of the authentication process, the authentication server 6 will provide 111 the secure system 20 with the identity 28.

Various modifications of the methods described above are of course possible and will be readily apparent to a person skilled in the art. Some of the modifications will now be described. For example, the method is not limited to a mobile telephone and can also be set up to recognize the calling line identification of the user's fixed line telephone.

Although the system may be configured as described above such that the requester makes an access request and then communicates with the telecommunications server via the telecommunications device, it may alternatively be configured to allow the user to communicate first and then make an access request. An advantage of this latter configuration is that once the user has communicated with the telecommunications server, the telecommunications device can then be used for other purposes including, for example, accessing the Internet.

As a further modification, the system may be configured to include a plurality of caller identification devices and telecommunications servers in different locations, all connected to the authentication server via TCP/IP links. The caller identification devices and telecommunications servers may be located in different countries or different telecommunications regions, allowing the requester to communicate without an international or ‘out-of-region’ call. This also allows the caller identification devices to identify the unique identifier of the telecommunications device by using a local CLI service, which is important as CLI services are not always available in international or ‘out-of-region’ calls.

Although the system may be configured as described above to use passcodes, it may alternatively be configured to use a biometric method for example a fingerprint or an iris scan.

The system may be configured to limit access to a predetermined number of unique identifiers, for example telephone calls, from any one telecommunications device, for example a mobile telephone, within a predetermined time period, for example a day. It may be desirable, for example, to limit the number of successful access requests for online voting to one vote only, during the time the secure computer system hosting the voting application is available.

The system may be configured where the access device, access software and/or the network communications are not a PC, browser or Internet connection respectively. For example, in a vending machine application the invention may be used to authenticate purchasers, and may implement these elements as a different interface between the purchaser and the authentication server, for example a direct user interface and a local area network.

The system may be configured to use a device that has two separate communication channels, such as a voice channel and a data channel. For example, the system may be implemented using devices that combine a networked computing device with a telephone that may be controlled by a computer program. This may for example be a mobile phone with GPRS and java capability, or an enhanced PDA device such as produced by Blackberry, or a portable computer that includes a cellular telephone. Such devices can execute downloadable objects.

Some of the steps in the authentication process described in the examples may be automated to make operation easier and to improve security.

For example, FIGS. 1, 2a, 3a, 4a and 5a show an optional integrated device 102, which includes an access device 2, access software 3, a telecommunications device 8, a unique identifier 9 and access to network communications 4 and a telecommunications network 10.

When an integrated device 102 is used, in the first step 50 of the authentication process, a requester 1 who wishes access to the secure computer system 20 makes an access request 40 to the authentication server 6 via network communications 4. Instead of being prompted to quote the unique identifier 9 of his telecommunications device 8, a program object is automatically downloaded to the combined device 102 and executed. During execution, the unique identifier 9 is obtained from the combined device 102 and submitted as access request 40 to the authentication server 6.

In the second step 51 of the authentication process, the requester I need not communicate to the telecommunications server 12: this is done automatically by the program object.

1. A method of controlling access, comprising:
detecting at least one access request comprising a specified caller number and storing the specified caller number and the time of the access request;
detecting at least one call, identifying a caller number associated with the call, and storing the identified caller number and time of the call; and
denying the access request unless the specified caller number of the access request matches an identified caller number, and the time between the access request and the call is less than a predetermined period.

2. The method of claim 1, further comprising:
storing a set of caller numbers;
comparing the specified caller number contained in the access request with the stored set of caller numbers; and
denying the access request unless the specified caller number matches one of the stored set of caller numbers.

3. The method of claim 2, further comprising:
storing a set of passcodes, each passcode being associated with a stored caller number;
detecting a passcode; and
denying the access request unless the detected passcode matches the stored passcode associated with the specified caller number.

4. The method of claim 2, wherein the specified caller number of the access request matches the identified caller number and matches one of the stored set of caller numbers, and the time between the access request and the call is less than the predetermined period, the method further comprising:
storing a set of identity codes, each identity code being associated with a stored caller number; and
providing the identity code associated with the specified caller number to a third party.

5. The method of claim 1, wherein the access request and the call are received via different channels of communication.

6. The method of claim 1, wherein the access request is a request to access to a secure computer system.

7. The method of claim 1, wherein the access request is a request for access via a computer system to a resource, location or event.

8. A system for controlling access, comprising:
first detecting means for detecting at least one access request that comprises a specified caller number, and first storing means for storing the specified caller number and the time of the access request;
second detecting means for detecting at least one call, identifying means for identifying a caller number associated with the call, and second storing means for storing the identified caller number and time of the call; and
access control means for denying the access request unless the specified caller number of the access request matches an identified caller number, and the time between the access request and the call is less than a predetermined period.

9. The system of claim 8, further comprising:
store means for storing a set of caller numbers;
and comparison means for comparing the specified caller number in the access request with the stored set of caller numbers;
wherein the access control means denies the access request unless the specified caller number matches one of the stored set of caller numbers.

10. The system of claim 9, further comprising:
storage means for storing a set of passcodes, each passcode being associated with a stored caller number; and
detection means for detecting a passcode;
wherein the access control means denies the access request unless the detected passcode matches the stored passcode associated with the specified caller number.

11. The system of claim 9, wherein the specified caller number of the access request matches the identified caller number and matches one of the stored set of caller numbers, and the time between the access request and the call is less than the predetermined period, the system further comprising:
storage means for storing a set of identity codes, each identity code being associated with a stored caller number;
the system being configured such that in the case of a successful access request, the identity code associated with the specified caller number is provided to a third party.

12. The system of claim 8, wherein the access request and the call are received via different channels of communication.

13. The system of claim 8, wherein the access request is a request for access to a secure computer system.

14. The system of claim 8, wherein the access request is a request for access via a computer system to a resource, location or event.
